(19) United States
(12) Patent Application Publication
(10) Pub. No.: US 2011/0258172 A1
(43) Pub. Date: Oct. 20, 2011

(54) Selection of Images

(75) Inventors: James Lee West, Sandford on Thames (GB); Kaldip Chohan, Coventry (GB)

(73) Assignee: Alamy Limited

(21) Appl. No.: 13/085,113

(22) Filed: Apr. 12, 2011

(30) Foreign Application Priority Data
Apr. 19, 2010 (GB) 1006494.7

(51) Int. Cl. G06F 17/30

(52) U.S. Cl. 707/706; 707/E17.019; 707/E17.109

(57) ABSTRACT

This invention relates to problems arising from searching a large, online image data set. The invention improves the ability of customers to search across large catalogues using keywords when those keywords have not been specified in advance. This invention achieves this by taking diverse metadata, both structured and unstructured, from diverse sources and translating them into a highly structured system for presenting to users.

### CROSS REFERENCE TO RELATED APPLICATION

The present application claims priority to Great Britain Application No. GB1006494.7 filed Apr. 19, 2010. The entirety of the aforementioned reference is incorporated herein by reference for all purposes.

### BACKGROUND OF THE INVENTION

The invention relates to the selection of images, and more particularly to the selection of images from a search of a large, online image data set, such as a collection of photographs.

Up until now, catalogues wishing to filter keyword results have had to enforce a predefined list and a controlled, limited language in either a flat or hierarchical form. This is viable where the sources of the material (in this case images and image metadata) are controlled (e.g. when the suppliers of the data have agreed to conform to a specification). Alternatively, the catalogue holder must edit the incoming metadata to ensure it meets the specification. Both approaches provide the structured keywording necessary to provide users with filters to enable them to filter results effectively according to both the attributes of an image (e.g. size and dimensions) and the contents of the image (e.g. number of people, ethnicity). However, this is time-consuming and expensive. It also constrains the amount of new photographic material that can be prepared for sale per unit of time.

Hence, there exists a need in the art for systems and methods to obviate or mitigate at least some of the problems set out above.

### BRIEF SUMMARY OF THE INVENTION

The invention relates to the selection of images, and more particularly to the selection of images from a search of a large, online image data set, such as a collection of photographs.

Various embodiments of the present invention provide a means by which catalogues that source material from a wide variety of content creators where the opportunity to control and regulate the input of metadata and, in particular, keywords is not practical can, nevertheless, present user with an effective means of filtering result sets.

In some cases such embodiments of the present invention achieves the aforementioned results by taking diverse metadata, both structured and unstructured, from diverse sources and translating them into a highly structured system for presenting to users.

Other embodiments of the present invention provide methods for analyzing text data for an image (or document) in order to assign it specific attributes that can be later specified by users to find relevant results. Such methods apply rules when analyzing text from the image (or document) metadata to ascertain if a given attribute or range of attributes can be applied to that image (or document). For any given attribute, the method may be just to check for the presence of words or phrases in the metadata. However, the method may also include confirming that certain other words are absent.

In accordance with a first aspect, the present invention provides a method for populating predefined search filters to the user. When the user selects a filter, the search filter algorithm conducts a complex database query to recover relevant results based on the presence of the attributes as defined above.

Various embodiments of the present invention provide methods for selecting images to be presented to a user as a result of a search through an image catalogue conducted by a search engine. Such methods include: receiving selection search criteria from the user according to the image required by the user, monitoring unstructured textual data associated with each image in the image catalogue and producing a set of structured search attributes therefrom, selecting images form the image catalogue having associated search attributes corresponding to the required search criteria, and presenting the selected images for viewing by the user.

Other embodiments of the present invention provide computer readable storage media incorporating a computer program for carrying out a method for selecting images to be presented to a user as a result of a search through an image catalogue conducted by a search engine. The method includes: receiving selection search criteria from the user according to the image required by the user, monitoring unstructured textual data associated with each image in the image catalogue and producing a set of structured search attributes therefrom, selecting images from the image catalogue having associated search attributes corresponding to the required search criteria, and presenting the selected images for viewing by the user.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a schematic diagram illustrating an attribute acquisition method for each item in an index of photographs in accordance with some embodiments of the present invention.

FIG. 2 diagrammatically illustrates a possible implementation of one or more embodiments of the present invention to provide where the attributes derived from an unstructured source of image metadata are stored in a database for retrieval by a search engine. These attributes provide the structure for the user to be able to effectively filter search results.

### DETAILED DESCRIPTION OF THE INVENTION

The invention relates to the selection of images, and more particularly to the selection of images from a search of a large, online image data set, such as a collection of photographs.

Various embodiments of the present invention relate to the selection of images, and is concerned with the problems arising from searching a large, online image data set, such as a collection of photographs. As just one of many advantages, some embodiments of the present invention provide an ability to customers to search across large catalogues of photographs from different content creators provided for sale/licensing using keywords when those keywords have not been specified in advance. The methods of image keywording are variable and may include one or more of:

Automated with a variety of preset categories keywords and categories of keywords

Other, intermediate annotation systems constrained by the needs of other catalogues

In-catalogue annotation and keywording

The described embodiment may for example include a filter relating to the age range of some or all of the people in an image. Such a filter enables the user to be presented with a list of age ranges ranging from the general (child, teenager) to the more specific (40-50). In the case of “child”, the source keyword metadata may well include the term “child”. However, it is just as likely to have “children”, “kids”, “4 year old” “age four” etc. the invention uses algorithms, look up tables etc to establish beyond reasonable doubt whether or not an image contains people where one or more of them is a child.

This approach may be extended to include other aspects of the content of the image including: ethnicity of the people in the image, the viewpoint of the image and the location of the shot. The search filter algorithm contains look-up tables to associate the user-selected term with an otherwise ambiguous set of keyword terms. The invention also has a contextual engine where the mapping of the user-selected term of the keyword varies according to other search terms applied with the session. For example, a user may apply the filters: Gender: Man and Ethnicity: African American and Number of People The first of these will of course include rules to exclude women from the search results.

The ordering of results defined within the predefined filters can also be preloaded with other factors which influence order such: as the geographic location of the customer, past search activity and past purchase activity. The algorithm may also include a feedback mechanism such that results improve with time. Users can notify the service of an image not being relevant to the results. This response is held in a database that stores all search records that have been flagged by users as incorrect. This database includes a processing engine to determine the significance of each entry or set of entries. The significance engine variables in processing may include: the type of users (customer, contributor, unknown); user significance (a measure of activity in terms of vests, clicks, zooms, and purchasing history); image significance (number of complaints); contributor significance (number of images, number of complaints, number of zooms, and number of sales). In addition, the algorithm may include a weighting engine to control the significance of a match of a predefined term to a keyword based on the field in which it appears, its position in the field and other ranking factors including the success of the contributor in terms of sales, zooms and views in general and for specific markets.

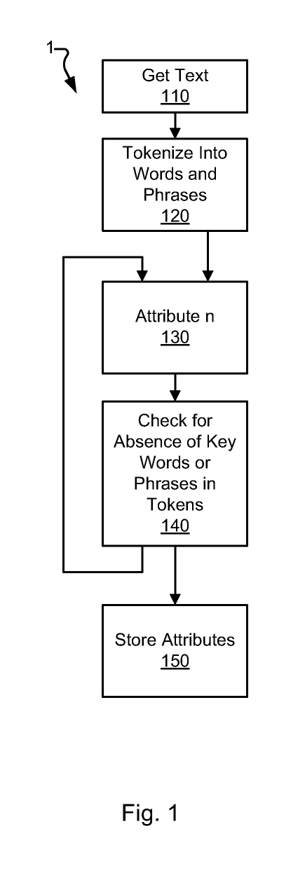

Turning to FIG. 1, a flow diagram 1 shows a method in accordance with some embodiments of the invention for attribute acquisition for each item in an index of photographs is shown. The depicted embodiment can be used to parse the metadata of each image in the catalogue. In a first step (block 110) the text found in the metadata is extracted. In a second step the text is parsed and reduced to tokens consisting of keywords and phrases. These first two steps are common in many indexing systems. In the following three steps (blocks 120, 130, 140), each attribute that has been predefined, and the tokens are scanned for the presence or absence of key words or phrases. For example, if the attribute in question is whether the image contains images of people with African ethnicity, the following steps are followed:

Block 120: attribute is African ethnicity

Block 130:
a) presence of words and other tokens to indicate that the image contains people (eg: people, person, child, adult, baby etc)
b) presence of words and other tokens to indicate that the image contains images of people of African ethnicity

Block 140: absence of words in other tokens that indicate the image may not contain people or that the people in the image may not be of African ethnicity (eg the presence of the word “American” proximal to the word “African”).

Block 150: stores the results for the attributes that have been analysed.

This can then be used to provide a means by which the user can filter search results in a structured interface.

It will be appreciated that such an embodiment provides a means of applying values to each of a plurality of images within different collections in a group of images selected by a search engine, and of thereby providing a discrete set of attributes based upon variable, apparently indeterminate metadata.

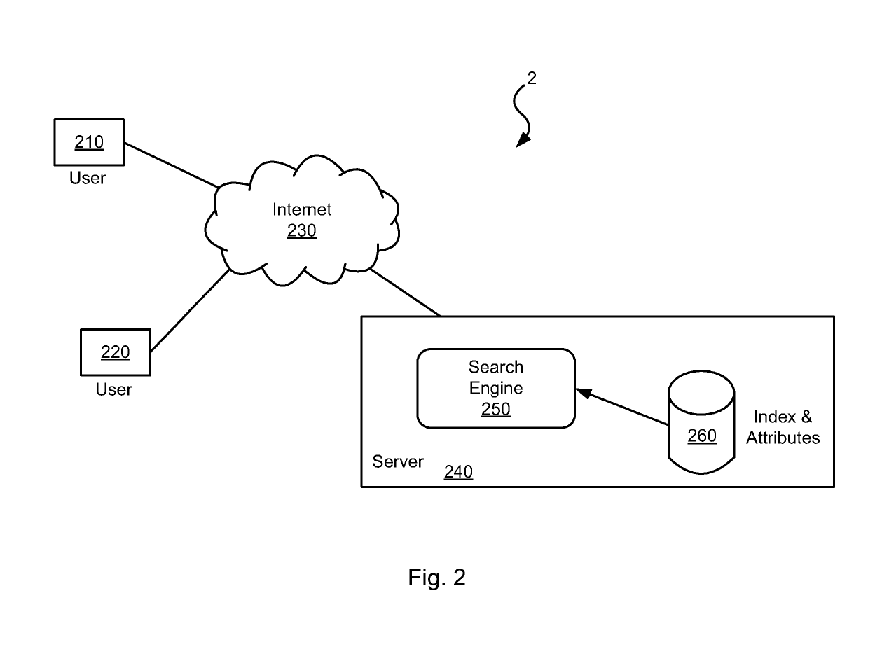

Turning to FIG. 2, one possible implementation of a system 2 providing attributes from an unstructured source image is illustrated. In particular, metadata corresponding to the respective images is stored on an index an attributes data base 260 that is accessible using a search engine 250 that is implemented on a server 240. Server 240 may be accessed by users 210, 220 via the Internet 230. The attributes stored on index and attributes data base 260 provide the structure for the user to be able to effectively filter search results. Search engine 250 also includes a translator for monitoring unstructured textual data associated with each image in the image catalogue and for producing a set of structured search attributes therefrom, and a filter for selecting images from the image catalogue having associated search attributes corresponding to the required search criteria. In some cases, the translator is arranged to process the textual data through the use of look-up tables corresponding to the required search criteria. In various cases, the filter is arranged to select images according to the presence of certain words or phrases in the textual data. In one or more cases, the filter is arranged to select images according to the absence of certain words or phrases from the textual data. In particular cases, the filter is arranged to order results according to other factors which influence order such as the geographic location of the user, past search activity of the user and past purchase activity of the user. In some cases, the aforementioned filters may include a feedback mechanism such that results improve with time, and/or provide the facility to enable users to indicate an image as not being relevant to the results. The processing engine may be used to determine the significance of each entry or set of entries. In addition, users 210, 220 may each include a display for presenting the selected images for viewing by the user.

It will be appreciated that various modifications can be made to the described embodiments without departing from the spirit and scope of the present invention. In conclusion, the invention provides novel systems, devices, methods and arrangements for fault detection. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A system for selecting images to be presented to a user as a result of a search through an image catalogue conducted by a search engine, the system comprising:
a processor;
an input for receiving selection search criteria from the user according to the image required by the user,
a translator for monitoring unstructured textual data associated with each image in the image catalogue and for producing a set of structured search attributes therefrom,
a filter for selecting images from the image catalogue having associated search attributes corresponding to the required search criteria, and
a display for presenting the selected images for viewing by the user.

2. A system as claimed in claim 1, wherein the translator is arranged to process the textual data through the use of look-up tables corresponding to the required search criteria.

3. A system as claimed in claim 1, wherein the filter is arranged to select images according to the presence of certain words or phrases in the textual data.

4. A system as claimed in claim 1, wherein the filter is arranged to select images according to the absence of certain words or phrases from the textual data.

5. A system as claimed in claim 1, wherein the filter is arranged to order results according to other factors which influence order such as the geographic location of the user, past search activity of the user and past purchase activity of the user.

6. A system as claimed in any preceding claim, wherein the filter includes a feedback mechanism such that results improve with time.

7. A system as claimed in any preceding claim, wherein the filter provides the facility to enable users to indicate an image as not being relevant to the results.

8. A system as claimed in any preceding claim, including a processing engine for determining the significance of each entry or set of entries.

9. A method of selecting images to be presented to a user as a result of a search through an image catalogue conducted by a search engine, the method comprising:
receiving selection search criteria from the user according to the image required by the user,
monitoring unstructured textual data associated with each image in the image catalogue and producing a set of structured search attributes therefrom,
selecting images form the image catalogue having associated search attributes corresponding to the required search criteria, and
presenting the selected images for viewing by the user.

10. A computer readable storage medium incorporating a computer program for carrying out a method for selecting images to be presented to a user as a result of a search through an image catalogue conducted by a search engine, the method comprising:
receiving selection search criteria from the user according to the image required by the user,
monitoring unstructured textual data associated with each image in the image catalogue and producing a set of structured search attributes therefrom,
selecting images from the image catalogue having associated search attributes corresponding to the required search criteria, and
presenting the selected images for viewing by the user.
